(19) United States
(12) Patent Application Publication
(10) Pub. No.: US 2005/0080634 A1
(43) Pub. Date: Apr. 14, 2005

(54) Method and network element for paying by a mobile terminal through a communication network

(75) Inventors: Liisa Kanniainen, Parola (FI); Tapani Lumme, Helsinki (FI); Sirpa Liukkonen, Helsinki (FI); Marti Siniharju, Helsinki (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/488,778

(22) PCT Filed: Sep. 6, 2001
(86) PCT No.: PCT/EP01/10278

(51) Int. Cl. G06F 17/60

(52) U.S. Cl. 705/1; 705/39; 705/40

(57) ABSTRACT

The present invention proposes a payment method for paying by a mobile terminal (1) through a communication network, the method comprising the steps of:—providing (S2) information on a transaction effected with a third party (2) using the mobile terminal (1),—judging (S4, S6), whether said information fulfills a predetermined criterion of a plurality of predetermined criteria, and—selecting (S5, S7, S8), dependent on the result of said judging step, a corresponding one out of a plurality of payment modes (8, 9, 10; Mode 1, Mode 2, Mode 3) for said transaction.

### FIELD OF THE INVENTION

The present invention relates to a payment method for paying by a mobile terminal through a communication network, and it relates also to a correspondingly adapted network element.

### BACKGROUND OF THE INVENTION

As a result of recent developments, the use of communication terminals such as wireless terminals known as mobile phones and/or mobile stations MS has widely spread. Together with the spreading of mobile station usage, development of so-called value added services offered to the users of the mobile stations, i.e. the subscribers to a communication network, finds an increasing interest.

For example, there is offered a service, by means of which a subscriber to a communication network (as a customer) can be billed for a transaction effected with a third party (vendor) using the subscriber's terminal device. Stated in other words, the necessity of having credit card and/or cash money or another means for payment could be replaced by possessing a mobile station and having subscribed to a communication network run by the network operator.

Thus, in greater detail, a third party as a vendor of some goods or as a service provider providing some service such as for example taxi driving, has a vending apparatus (e.g. adapted to dispense the goods) installed at the location of the goods or at the service provisioning (e.g. in the taxi).

Then, in case the mobile station user as a customer makes a contract with the vendor/service provider, he has to decide how to pay for the goods/service, e.g. by cash payment, credit card payment or the like, or payment via his mobile station.

For payment via his mobile station, the user (customer) has to make a call to the vending apparatus via the communication network. The network, more particularly, a network element such as an exchange within the network (e.g. a mobile services switching center MSC according to GSM standard (GSM=Global standard of mobile communication)) routes the call to the called destination. Such a routing may take different routes within the network to establish a communication path between the mobile station and the vending apparatus. For example, document U.S. Pat. No. 6,141,410 discloses possibilities for routing a call in a communication network based on call attributes.

In case a user decides to pay via his mobile station, document EP-B1-0 669 031 discloses an authentication procedure for authenticating a subscriber prior to payment. Such authentication is nearly always required in order to minimize a risk of fraudulent behavior of the customer/user of the mobile station.

Nevertheless, in case the payment is effected via the mobile station of the subscriber, the charge for the bought goods/offered services is billed to the subscribers telephone bill by the network operator and the operator has the risk that the telephone bill or at least part of it remains unpaid. As prices for goods that can be bought using the mobile station may reach significant heights, the risk of the operator increases accordingly.

In order to further minimize this risk, a network operator keeps a record of fraudulent private persons, e.g. those having previously shown fraudulent behavior, or has to define kind of a fraudulent behavior profile. This, however, imposes an additional burden on the network operator and in case of a payment via a mobile station also implies an additional step after authentication in order to make sure that the authenticated subscriber is not known as (potentially) fraudulent, to thereby filter out risky transactions that might remain unpaid.

Also, the risk could be minimized by preventing some transactions such as buying goods or using offered services to be paid using the mobile station. This, however, would impose some inconvenience to the subscriber.

Further, for example the operator would require to have information about the users' bank connections. This however bears a risk that the anonymity cannot be guaranteed.

### SUMMARY OF THE INVENTION

Hence, it is an object of the present invention to provide an improved method and network element for paying by a mobile terminal through a communication network, which is free from above mentioned drawbacks. The goods to be bought can be digital content such as music, multimedia (including text, images, audio and video, which can be delivered instantly to the mobile terminal using buyer and the digital content can be protected with digital rights management, DRM arrangement.

According to the present invention, this object is for example achieved by a payment method for paying by a mobile terminal through a communication network, the method comprising the steps of: providing information-on a transaction effected with a third party using the mobile terminal, judging, whether said information fulfills a predetermined criterion of a plurality of predetermined criteria, and selecting, dependent on the result of said judging step, a corresponding one out of a plurality of payment modes for said transaction.

According to favorable further developments of the present invention,
said information on said transaction is cost information representing the costs accrued for said transaction;
said information on said transaction is indicative of a type of transaction;
according to the selected payment mode, said information on said transaction is transferred to a corresponding destination;
if said selected payment mode is selected for transactions involving payments that are less than a specific amount, the payment amount being added to the communication network operator's bill for the user of the mobile terminal, and the information on said transaction is transferred to the billing server;
for a specific selected payment mode, said information on said transaction is accumulated for plural individual transactions before being transferred to said corresponding destination;
if said selected payment mode is selected for transactions involving payments that are equal or greater than a specific amount, said information on said transaction is individually transferred to said corresponding destination;
said predetermined criterion is user specific, and said method further comprises a step of providing information about said predetermined criterion for a user; and
a transaction comprises the steps of choosing, by the mobile terminal, a vending machine, disclosing, by the vending machine, a telephone number which the customer, by means of the mobile terminal, may dial for buying a good/service offered by said vending machine, and dialing said disclosed telephone number.

Additionally the digital content which is bought and instantly delivered to the mobile buyer and is protected with digital rights arrangement the bought product, which is the encrypted or otherwise protected digital content can be used in the terminal after a key or set of keys is received from the network to the mobile terminal so that the digital content can be decrypted or interpreted with assistance of the key (or set of keys). Further more the key to interpret or encrypt digital content can be stored in one of following network elements: vending machine or certificate agency server. After the digital content is bought by the mobile terminal user the key of the digital rights protecting the digital content can be stored in the mobile terminal or alternatively in the user information register in the network.

Still further, according to the present invention, the above object is for example solved by a network element adapted to carry out the method as defined above.

Accordingly, with the present invention the payment for a transaction between the user of the mobile station and e.g. a vending apparatus of a vendor as a third party is transparent for the user who does not have to take care of the payment mode selection. Also, the risk of the network operator that a bill will not be paid is reduced, as the payment server selects the mode of payment according to the information on the transaction performed (e.g. based on the sum to be charged/billed, or on the type of transaction such as “buy” or “service”, or on a combination of the both).

Stated-in other words, it is enabled that some upper or lower limits (by means of which different criteria are defined) are used in such a way that those transaction information such as e.g. sum of costs that are not major costs can be charged later on by the communication network operator for instance, while those costs that represent a certain value that may cause a lost of revenue if the bill remains unpaid can safely be paid using another payment mode such as a credit card or bank payment. Note that the payment modes are selectable also dependent on the type of transaction and/or type and costs of transaction, or on the basis of other transaction information such as subscriber identification or subscriber group or subscriber profile specifically.

Thus, in general, the network element according to the present invention referred to as payment server enables plural payment modes to a user, the alternative payment mode to be used being selected according to the information on the transaction (e.g. type of transaction and/or price of transaction) performed by the user with a third party (vendor/service provider). Several margins can be specified which are used to define a certain payment mode. The margins may be subscriber specific or subscriber group/profile specific or transaction information specific.

For example, all payments below a certain risk level (e.g. price) that the operator has defined in accordance with the payment server owner (third party) are to be charged by the operator attached to the periodic bill of the subscriber for subscribing to and usage of the communication network. Some money margins that are not to be included in the subscriber bill issued by the network operator may be specified in the payment server, so that corresponding sums are to be transferred further to the bank institute of the subscriber (or to his credit card agency), either in “real time”, i.e. immediately and/or as soon as possible after completion of the transaction, or as a bulk transfer, i.e. information on an individual transaction is accumulated for plural of such individual transactions before being transferred to the corresponding destination such as the bank of the subscriber (e.g. monthly or weekly or any other interval).

Also, advantageously according to present invention the operator would no longer require to have information about the users' bank connections. This removes a risk that the anonymity cannot be guaranteed while taking a burden away from the operator of the communication network to maintain a record of the users' bank connections.

Also advantageously the accumulated plural transactions having reached the limit of the user's specific predetermined criterion or defined fraud limit, the terminal is requested to sign payment transaction, which user given signature is validated in a server of a certificate authority (located in a bank or a credit card agency).

### BRIEF DESCRIPTION OF THE DRAWINGS

The features, objects and advantages of the present invention will become more fully apparent with reference to the accompanying drawings, in which:

FIG. 1A shows a rough overview of network elements and terminals involved in implementing the present invention;

FIG. 1B) shows a rough overview of network elements and terminals involved in implementing the present invention, which include a certificate agency;

FIG. 2a shows a signaling diagram of the signaling between some of the terminals and network elements shown in FIG. 1A, and

FIG. 2b shows another signaling diagram of the signaling between some of the terminals and network elements shown in FIG. 1A, and

FIG. 3 shows an example of mapping transaction type information to payment modes.

### DETAILED DESCRIPTION OF THE EMBODIMENTS

The present invention will now be described in greater detail with reference to the drawings.

Generally, in connection with the present invention, a mobile station (MS) acts as an interface for the user, buyer or consumer for accessing a communication network having a network element according to the present invention and adapted to implement the method according to the present invention. Such a mobile station (MS) may be a WAP-capable cellular telephone, a Hypertext Markup Language (HTML) capable cellular telephone, or a cellular telephone with a processor-based system connected to it. Such a processor-based system may be, but is not limited to, a laptop computer, palm computer, or other portable computing devices including the WAP-capable telephone alone. The mobile station (MS) communicates through the telecom infrastructure provided by the communication network to a banking service provider server through a gateway. The telecom infrastructure may be, but is not limited to a cellular telephone control protocol, such as GSM (Global System for Mobile Communications) telephony system or any other suitable access protocol. The interface between the mobile station and a vending machine is adapted to the communication infrastructure which may be, but is not limited to, a direct physical connection, low power short range radio frequency (LPRF) connection such as Bluetooth™, infrared connection, an wireless IP (Internet Protocol) connection, hyper LAN or any other suitable means of communication. In turn the vending machine may communicate with the gateway and thus the local network operator service through, but not limited to, an internet protocol packet-switched network, a dial-up line over the public switched telephone network, or any other suitable means of communications. Therefore, the embodiments of the present invention are not limited to communications using the Internet. Further, the local network operator service may communicate to the buyer's home network operator service directly through the PSTN or via the Internet or any known data network. In addition, the home network operator service, the local network operator service and a gateway are all considered to be part of the mobile telephone infrastructure for billing and authentication, which serves to facilitate the purchase of goods and services.

It should be noted that the embodiments of the present invention will operate when the user is in the home network operator service area and thus the home network operator service and the local network operator service may be one and the same entity.

When the user or consumer is not in his home network operator service area, the user may still make purchases from seller (vending machine) if a roaming agreement exists between the local network operator service and the home network operator service. Further, the seller may be anyone selling a good or service from a street flower vendor to a department or clothing store. The seller may also be a seller of software or other digital products and may have a store front or may have a web site on the Internet. The goods to be bought can be digital content such as music, multimedia (including text, images, audio and video, which can be protected with digital rights management, DRM arrangement. If the user or buyer is outside of his home network operator service area, the local network operator service will submit an accounting record of the transaction between buyer and seller to the user's home network operator service for billing on the user's telephone bill as in selection criteria selected by the buyer.

Using the present invention it is possible for a buyer to utilize his mobile station similarly to a credit card to pay for goods and services wherever the user's home network operator service has established a roaming agreement with the local network operator service. As with the major credit cards, this could someday be worldwide if a universal cellular phone standard is established. Since digital signatures cannot be forged by any party that do not have access to the signing key, and since the signing key is never released outside the mobile station, it would be impossible for a third party eavesdropper, hacker, criminal, or the seller to either undetectably modify payment messages generated by a legitimate payer, or generate bogus payment messages purportedly coming from a legitimate payer. In addition, the buyer or user may utilize mobile station wherever his home network operator service has established a roaming agreement and his mobile station can interface to the local network operator service.

Embodiments of the present invention use the GSM (Global System for Mobile Communications) telephony system that employs algorithms in the mobile station (MS), such as, but not limited to, cellular phones and WAP-capable cellular phones, and the mobile telephone infrastructure for billing and authentication which controls authentication of the user and mobile station to prevent unauthorized access to the network and to provide encryption of the transmissions between users.

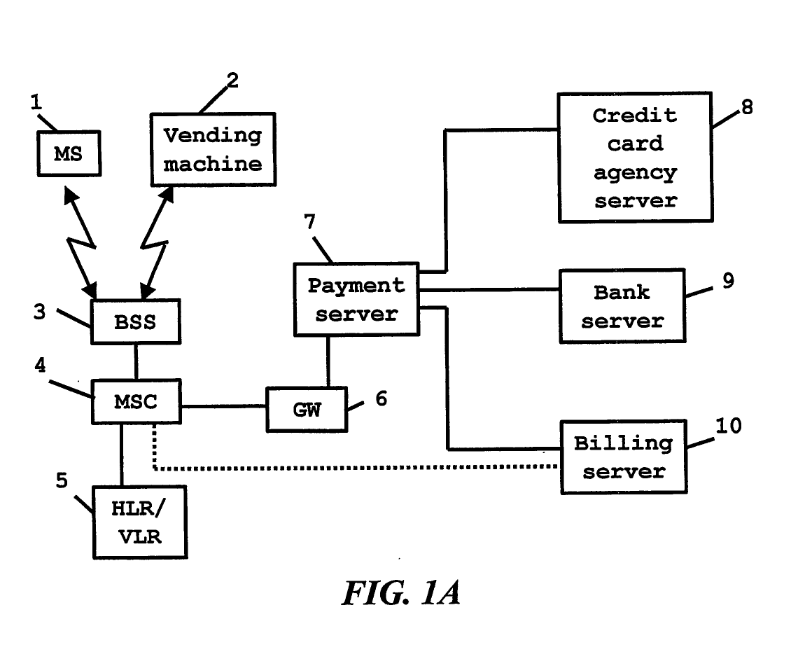

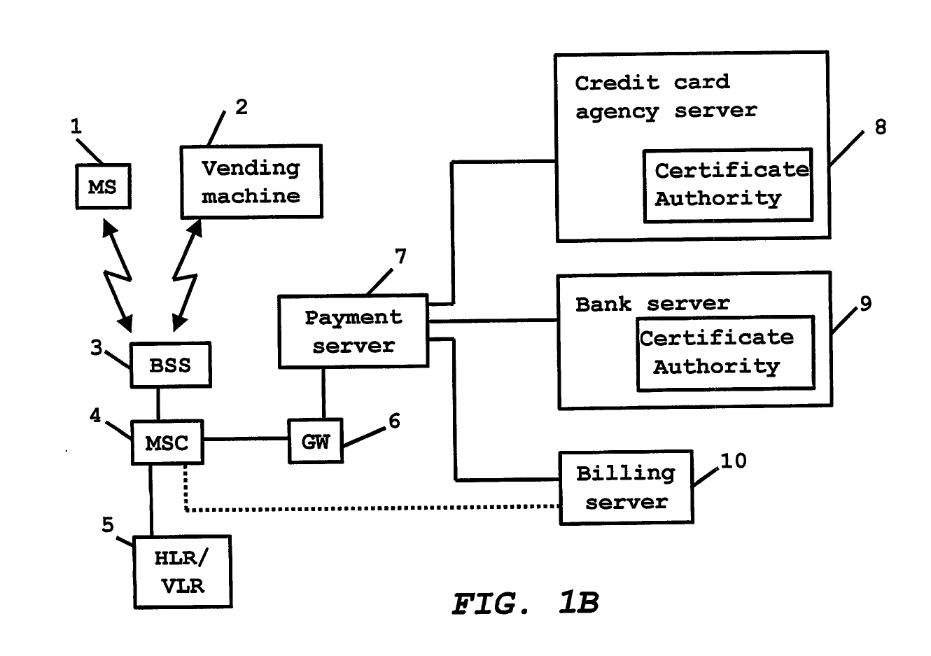

Now, with reference to the drawings, FIG. 1A shows a rough overview of network elements and terminals involved in implementing the present invention. A subscriber to the network and user of his terminal is represented by his mobile station MS 1. The mobile station MS 1 is adapted to communicate via and/or with the communication network 3, 4, 5, 6 as for example a mobile communication network according to GSM. The communication network is represented by a base station subsystem BSS3, connected to a mobile services switching center MSC 4, which in turn is connected to a home location register/visitor location register HLR/VLR 5. A VLR contains a copy of the subscriber data contained in the HLR. The (mobile) communication network, i.e. the MSC is connected via a gateway element GW 6 to a fixed network such as the Internet (not shown as such). Also, the MSC is connected to a billing server 10 of the communication network. The billing server collects subscriber data related to the subscription to and usage of the network by the subscriber and is adapted to issue regular bills for a respective subscriber so that the network operator may charge the subscriber for subscribing to the network or communicating via the network. As the communication network and its functionality as such is known, a further detailed description is omitted here.

The subscriber may have the possibility to be a customer to a third party. The third party is also known as selling entity. The third party is represented by a vending machine 2. A vending machine 2 may for example be a food dispensing machine, a ticket buying machine or the like. In such cases, the subscriber may, by means of his mobile station MS 1, initiate a transaction to buy a corresponding good from the owner of the vending machine 2. Nevertheless, the vending machine 2 may be a taxi with adapted equipment, so that the subscriber may initiate a transaction to obtain a corresponding transportation service from the owner of the vending machine, i.e. the taxi driver.

A transaction is initiated by the mobile station MS 1 initiating a call via the mobile communication network 3, 4 (BSS, MSC) to the vending machine. To this end, the vending machine 2 is identified by a telephone number, for example. In case the vending machine 2 offers plural goods for sale, a corresponding plurality of telephone numbers are available for the vending machine, each identifying a respective good and thus the price to be charged for the transaction of buying the good. The vending machine 2 responds to the call via the network, particularly the MSC thereof, so that the MSC gets information on the ongoing transaction (transaction information).

Transaction information may comprise the type of transaction such as “buy” or “service”, and/or the “price” of transaction the subscriber/customer is to be charged/billed.

Additionally the transaction may also include information of the seller if the payment server 7 is maintained or owned by other than the vending machine owner. Then more than one firm owning vending machines may use one payment server.

Note that the mobile station 1 may be equipped with (both not shown) a uniform resource agent of type 2 (URA 2) and/or with a WAP identity module (WIM) (which is similar to a subscriber identity module) (WAP =Wireless Application Protocol). The URA 2 may contain credit card or bankcard information to be used if a payment for the transaction is to be realized via a credit card agency or a bank.

The transaction information at the MSC is forwarded via the gateway element GW (and e.g. further via the Internet) to a payment server 7. Typically, the third party who also owns the vending machine 2 owns the payment server 7, but the third party may also rent such a payment server 7.

The payment server 2 as a network element judges whether said transaction information fulfill a predetermined criterion of a plurality of predetermined criteria, and selects, dependent on the result of said judging step, a corresponding one out of a plurality of payment modes for said transaction. Shown in FIG. 1A are three different examples for payment modes, each mode being represented by a corresponding destination to which information on said transaction is transferred to.

Namely, in one payment mode (mode 1), the transaction information is transferred to the (mobile) network operators billing server 10 for charging the subscriber together with his subsequent telephone bill. In another payment mode (mode 2) the transaction information is transferred to bank server 9 of the subscriber's bank for charging the subscriber's bank account. For example, such a charging could be effected after a predetermined time (in mode 2a) in regular intervals (daily, weekly, monthly or the like) together with accumulated charges for other individual transactions performed during that time. Thus the payments of each transaction is made off-line when compared to payments made in real time and immediately during or right after each individual purchase transaction has occurred. Alternatively, the charges accruing could be accumulated and charged to the subscriber's bank account if a certain predetermined amount has been reached (in mode 2b) by the sum of the prices to be charged for the number of performed transactions. Still further, in another mode (mode 3) the subscriber's bank account could be charged immediately for a performed transaction (e.g. if the price exceeds a certain limit). Alternatively, in a payment mode (e.g. mode 3a), it is not the subscriber's bank account but his credit card that is charged with the price for the performed transaction. To this end, a credit card agency server 8 is also connected to the payment server 7 in the example illustrated in FIG. 1A.

The connections between network elements transporting confidential data such as credit card numbers, bank account numbers, transaction data etc. should preferably be secure connections. For example, the connection from the MSC 4 via the gateway GW 6 to the payment server 7 could be a SSL secured connection (Secure Socket Layer), while the connections from the payment server 7 to the credit card agency server 8, bank server 9, billing server 10 could be based on VPN (Virtual Private Network) or encrypted/ciphered TCP/IP connections (Transmission Control Protocol/Internet Protocol). The gateway GW 6 could be a WAP gateway but also another gateway.

Referring back to the VLR 5 connected to the MSC 4, the VLR contains information on the subscriber necessary to communicate via the network, and particularly contains an information whether the subscriber is enabled to use the service for payment via his mobile station 1 and hence has access to the payment server 7 or not. This information is also contained in the HLR, as the information in the VLR is a copy of the information in the HLR.

In the VLR/HLR 5 there may be only a flag indicating that the payment server 7 is accessible by the subscriber's terminal MS 1. The confirmation of the transaction and the transaction information as such will be forwarded via a configured routing element (e.g. the MSC), by for example a secured TCP/IP connection via an external server and/or register (not shown) to the payment server 7. The external server may be physically part of the gateway GW 6, or of the payment server 7, but may also be provided separately therefrom. The external server/register is thus located between the payment server and the network element MSC of the network operator which serves the vending machine 2. The external register contains the information about the subscriber's/customers bank connection (bank institute, bank account), so that the communication network operator within its network element has no information about the subscriber's bank connection, thereby supporting anonymity of and security for the subscriber.

Alternatively, the network address of the payment server 7 (e.g. an IP address, Internet Protocol address) is saved in the HLR, which address is copied to a new VLR in case of a roaming subscriber.

In FIG. 1B) the connections between network elements transporting confidential data such as credit card numbers, bank account numbers, transaction data, user's digital signature etc. should preferably be secure connections. The connection from the MSC 4 via the gateway GW 6 to the payment server 7 could be a SSL secured connection (Secure Socket Layer), while the connections from the payment server 7 to the credit card agency server 8, bank server 9, billing server 10 could be based on VPN (Virtual Private Network) or encrypted/ciphered TCP/IP connections (Transmission Control Protocol/Internet Protocol). The certificate authority functionality can be integrated in the server of the credit card agency 8 or the bank 9 or alternatively a stand-alone server of certificate agency is in connection to server of the credit card agency 8 and or the bank 9. Then the connection between credit card company or bank server 8,9 and the certificate agency server could be based on VPN (Virtual Private Network) or encrypted/ciphered TCP/IP connections (Transmission Control Protocol/Internet Protocol). The gateway GW 6 may be a WAP gateway but also another gateway similarly as in FIG. 1A.

The key to interpret or encrypt digital content can be stored in one of following network elements: vending machine or certificate agency server.

If the key is located in the certificate agency server it is transferred from there when user signature and the buying transaction confirmation is validated by the certificate agency. Alternatively the key may be located in the digital content vending machine from where it is transferred to MS and stored for later use either in MS or in network register(s).

When the digital content is bought by the mobile terminal user the key of the digital rights protecting the digital content can be stored in the mobile terminal or alternatively in the user information registers HLR and VLR in the network.

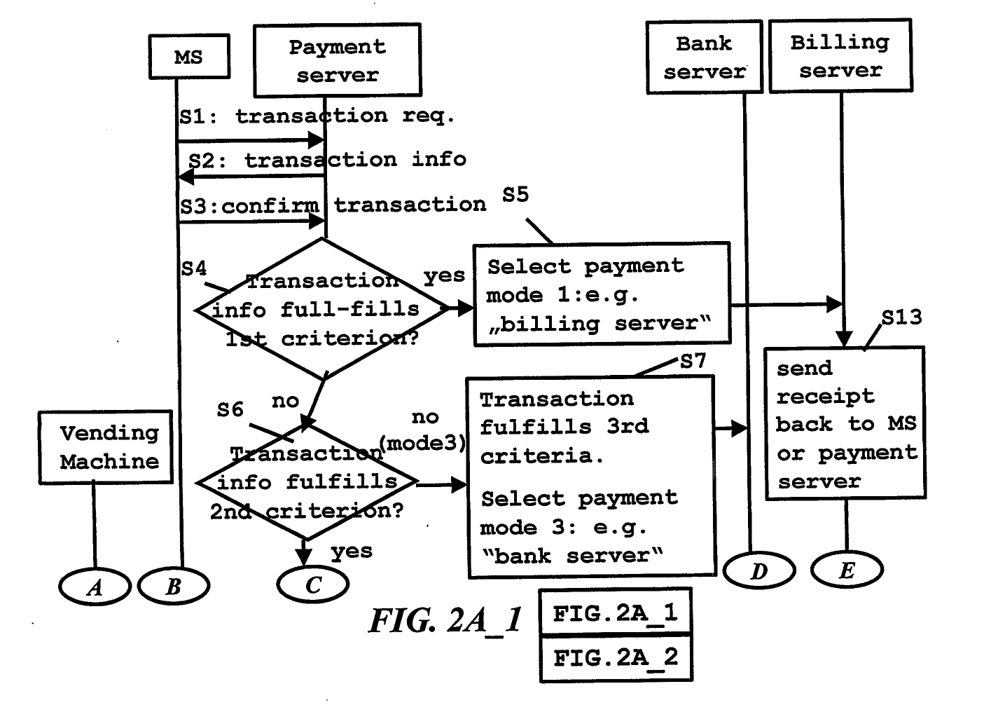

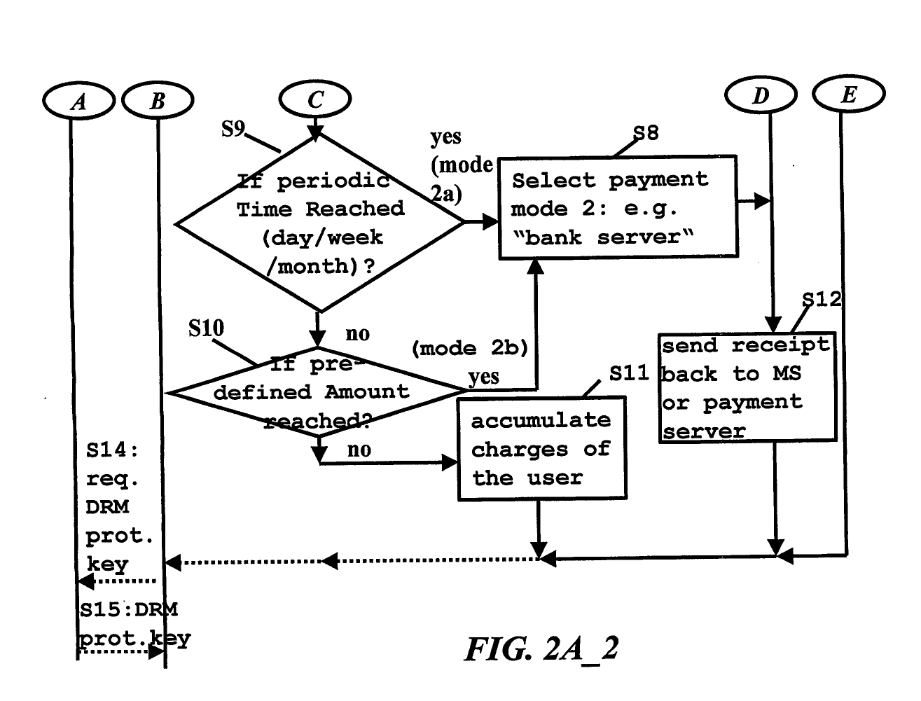

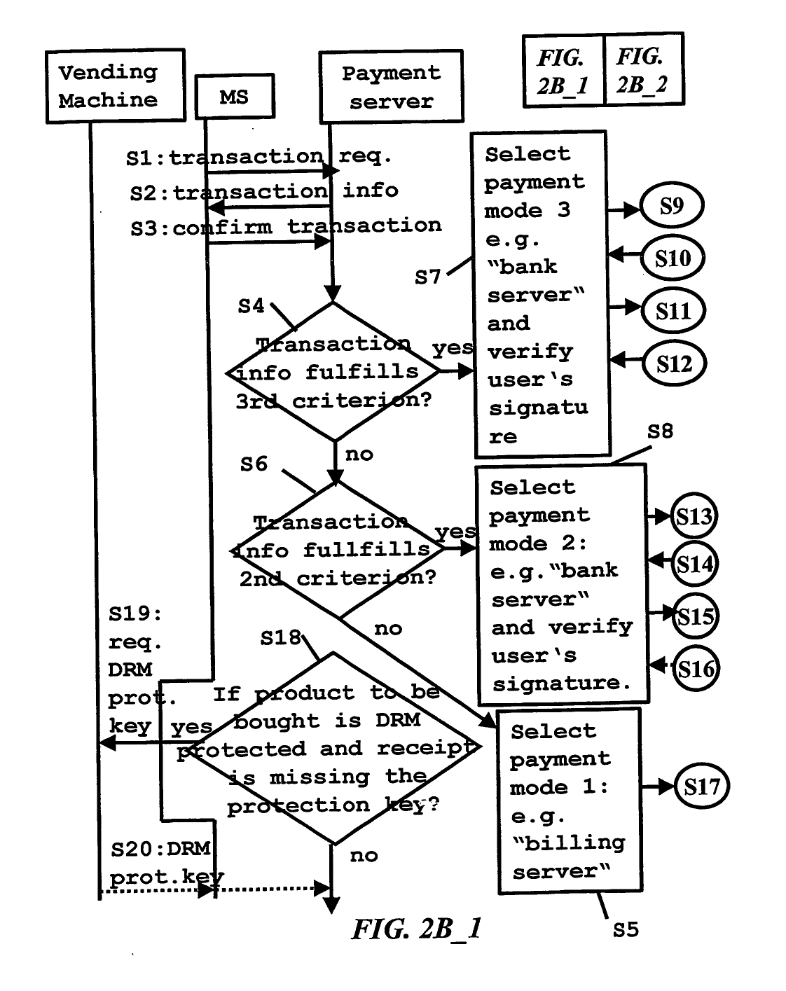

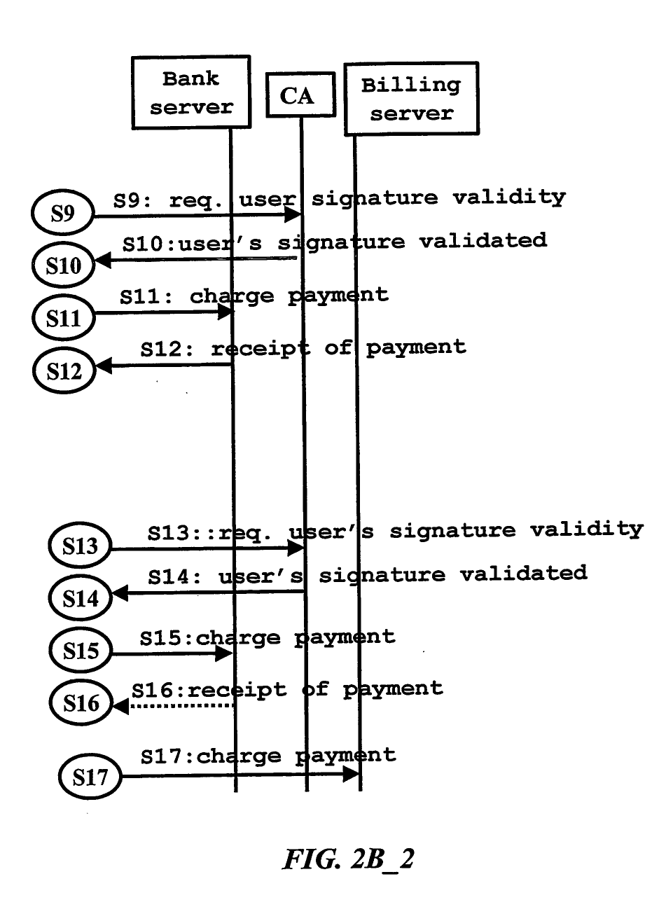

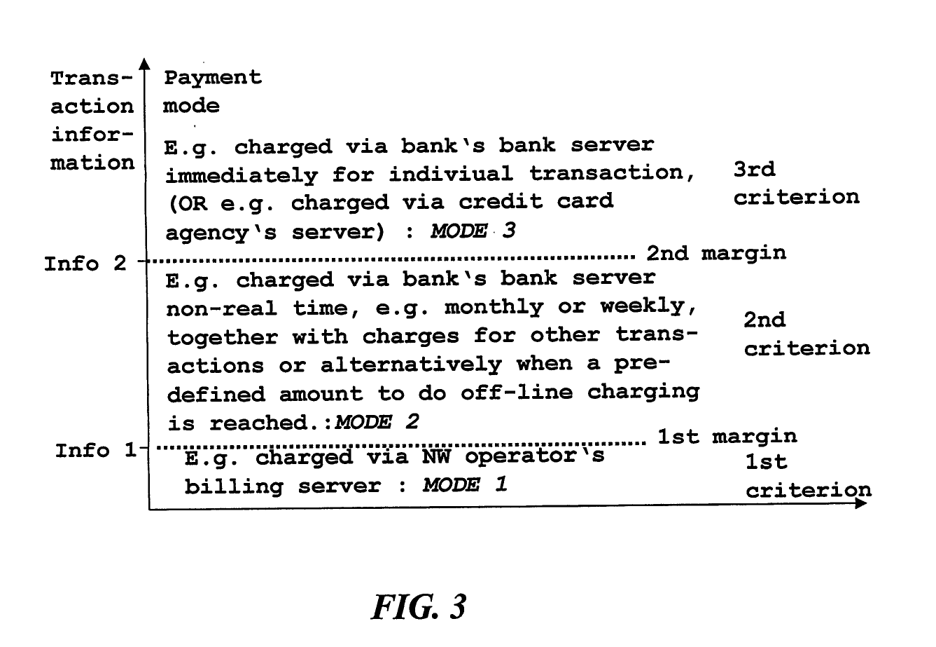

FIG. 2a and 2b show a signaling diagram of the signaling between some of the terminals and network elements shown in FIG. 1A. For better understanding of the description of FIG. 2a and 2b), it is firstly referred to FIG. 3.

FIG. 3 is showing an example of mapping transaction information to payment modes. As mentioned before, transaction information may comprise a transaction type information and/or transaction cost information. For example, a transaction type may be “buy” or “service”. Nevertheless, within such a type, sub-types may be defined. For example, “buy food” or “buy gasoline” could be defined as sub-types of transaction type “buy”.

Now, assuming that FIG. 3 shows a case for a specific user or a user group defined by a specific user group profile, it could be assumed for explanatory purposes that info 1 and info 2 represent different prices, with the price indicated by info 2 being higher than the one indicated by info 1. Then, info 1 and info 2, respectively represent a 1^{st} and 2^{nd} margin (or threshold). If an actual price of a performed transaction is below the first margin (info 1), a first criterion is matched and a payment mode is set to mode 1 as shown in the example of FIG. 3. If an actual price of a performed transaction is above the first margin (info 1) but below the second margin (info 2), a second criterion is matched and a payment mode is set to mode 2 (mode 2 includes earlier indicated mode 2a) and mode 2b)) as shown in the example of FIG. 3. Still further, if an actual price of a performed transaction is above the second margin (info 2), a third criterion is matched and a payment mode is set to mode 3 as shown in the example of FIG. 3.

The payment modes may differ from each other in the destination to which said information on said transaction is transferred to. Namely, whether a billing server 10 of the network, a bank server 9 of a bank institute of the subscriber or a credit card agency's server 8 is connected to the payment server 7 in order to actually charge the subscriber for the purchased goods or services. Also, the modes may differ in when the charges are billed. E.g. whether a price for a transaction is billed rather immediately and individually for a concerned transaction, or whether plural prices of individual transactions are collected/accumulated before being billed to the subscriber, e.g. at regular intervals or when a predetermined amount has been reached. Also, more than two margins may be defined, however, FIG. 3 shows only two margins to keep the explanation simple.

Still further, assuming a case in which FIG. 3 shows a case for a specific user or a user group defined by a specific user group profile, it could be assumed for explanatory purposes that info 1 and info 2 represent different transaction types and a price limit for such a transaction type. For example, info 1 could represent a type of “buy” combined with a price limit, while info 2 could represent a transaction type of “service” combined with a price limit. The price limits for different types of transactions may be set independently from each other. In such a case, for each type of transaction, two payment modes are defined dependent on whether the price is above or below the respective price limit. Of course, plural price limits per transaction type may be defined, so that more than two payment modes are selectable per transaction type.

The above described mapping information for mapping transaction information to payment modes is kept at the payment server shown in FIG. 1A.

Now, as shown in FIG. 2a, the subscriber requests by use of his terminal MS 1 for a certain transaction, step S1. The request is forwarded by the intermediate of the communication network, the vendor machine, and the network to the payment server 7, as already explained in connection with FIG. 1A. The payment server 7 returns transaction information received from the vendor machine such as price and or kind of good/service to be purchased to the mobile station MS 1, step S2. This serves for providing the user with a possibility to confirm the requested transaction. If the user wishes to confirm the requested transaction and to perform the requested transaction, he confirms this in step S3 to the payment server 7.

The payment server 7 in step S4 judges whether the transaction information fulfills a first predetermined criterion or not (e.g. whether the actual transaction information (e.g. price) is below the margin info 1 as indicated in FIG. 3.

If yes in step S4, the payment server 7 in step S5 selects payment mode 1 in accordance with the judgement (conforming to the example shown in FIG. 3), so that the transaction information is transferred for billing purposes to the network operators billing server 10.

If the transaction information does not fulfill the first criterion in step S4, the payment server 7 in step S6 judges whether the transaction information fulfills a second predetermined criterion or not (e.g. whether the actual transaction information (e.g. price) is above the margin info 1 and below the margin info 2 as indicated in FIG. 3.

If yes in step S6, the payment server 7 in step S8 selects payment mode 2 in accordance with the judgement (conforming to the example shown in FIG. 3), so that the transaction information is transferred for billing purposes to the bank server 8 of a bank where the subscriber maintains a chargeable bank account. The payment of accumulated transactions in mode 2 is transferred to the “bank server” when a periodic time is reached (day/week/month) in step S9 and condition of step S9 is fulfilled (=mode 2a). That mode 2a fulfilled condition in step S9 is the condition that is marked as one valid condition named as 2^{nd} criterion in FIG. 3. Alternatively in FIG. 2A in mode 2 the payment of accumulated transactions is transferred to the “bank server” if not a periodic time but a predefined amount is reached and condition in step S10 is fulfilled, which is the same as marked one valid condition named in the 2^{nd} criterion in FIG. 3.

If not in step S6, the payment server 7 in step S7 selects payment mode 3 in accordance with the judgement (conforming to the example shown in FIG. 3), so that the transaction information is transferred for billing purposes to the bank server 8 of a bank where the subscriber maintains a chargeable bank account.

The difference between mode 2 and mode 3 resides in, as shown in FIG. 3, that in mode 3 the sum to be charged is charged immediately for the individual transaction, while in mode 2 the sum is charged in non-real time, i.e. monthly or weekly or daily together with charges having accrued due to other transactions performed by the subscriber or accumulated charges of the subscriber's performed transactions reaches predefined limit (the second limit that is marked as 2^{nd} margin value in FIG. 3 and is different to the 1^{st} margin limit of FIG. 3.

If the bought product is DRM protected digital content the protection key (or set of keys) can be stored in one of following network elements: vending machine or certificate agency. If the DRM protection key(s) is located in certificate agency, which is integrated in the bank server the MS will receive the DRM protection key(s) in the receipt that is sent from the bank server. Alternatively the key may be located in the digital content vending machine from where it is transferred to MS when vending machine gets confirmation of the accepted payment to be made. The receipt of the payment can be sent to MS or it can be stored in the payment server. Depending on where the receipt of the payment is stored it is sent from either MS or payment server to vending machine if the receipt of the payment does not include the DRM key protection information. As a result the vending machine sends back the DRM protection key information (and if the receiving party is the payment server the protection key is sent further to the mobile terminal, MS. Since the DRM protected digital content is only one alternative product to be bought the DRM protection key transferring is optional feature and is presented with a dotted line in the FIG. 2A.

In FIG. 2B is shown signaling of network architecture in which the certificate agency functionality is located in a separate server other than the bank or credit card company server. First the subscriber requests by use of his terminal MS 1 for a certain transaction, step Si. The request is forwarded by the intermediate of the communication network, the vendor machine, and the network to the payment server 7, as already explained in connection with FIG. 1A. The payment server 7 returns transaction information received from the vendor machine such as price and or kind of good/service to be purchased to the mobile station MS 1, step S2. This serves for providing the user with a possibility to confirm the requested transaction. If the user wishes to confirm the requested transaction and to perform the requested transaction, he confirms this in step S3 to the payment server 7.

The payment server 7 in step S4 judges whether the transaction information fulfills a 3^{rd} or 2^{nd} predetermined criterion or not (e.g. whether the actual transaction information (e.g. price) is above or equal the margin info 1 as indicated in FIG. 3.

If yes in step S4 or in step S6 or in step S8 selects payment mode 2 or 3 in accordance with the judgment (conforming to the example shown in FIG. 3), so that the transaction information is transferred for billing purposes finally to bank or credit card server where the subscriber maintains a chargeable bank or credit card account. For simplicity we describe only the bank account and server although instead of sending the bill to the bank it can be sent to a credit card company and their server (or computer network of theirs). The payment of accumulated transactions in mode 2 is transferred to the “bank server” when a periodic time is reached (day/week/month) and the condition that is marked as one valid condition named as 2^{nd} criterion in FIG. 3 is met. Alternatively in FIG. 2B in mode 2 the payment of accumulated transactions is transferred to the “bank server” if not a periodic time but a predefined amount is reached and condition, which stands for the marked one of valid conditions named as 2^{nd} criterion in FIG. 3.

Before the transaction information is transferred for billing purposes to the bank server of a bank where the subscriber maintains a chargeable bank account a certificate agency is requested to validate user's signature. The payment server sends from step S7 or S8 a request of user's signature validity at step S9 (or S12). The certificate agency, CA server answers user validation back to payment server in step S10 (or S14).

If the bought product is DRM protected digital content the protection key (or set of keys) can be stored in one of following network elements: vending machine or certificate agency. If the DRM protection key(s) is located in certificate agency, which is integrated in the bank server the MS will receive the DRM protection key(s) in the receipt that is sent from the bank server. Alternatively the key may be located in the digital content vending machine from where it is transferred to MS when vending machine gets confirmation of the accepted payment to be made. The receipt of the payment can be sent to MS or it can be stored in the payment server. Depending on where the receipt of the payment is stored it is sent from either MS or payment server a request to have DRM protection key (in step S19) is sent to vending machine when the receipt of the payment did not include the DRM key protection information. As a result to the made request the vending machine sends back the DRM protection key information in step S20 (and if the receiving party is the payment server the protection key is sent further to the mobile terminal, MS. Since the DRM protected digital content is only one alternative product to be bought the DRM protection key transferring is optional feature and is presented with a dotted line in the FIG. 2B.

It is to be noted that various modifications to the example described above are conceivable. Namely, more than two margins with correspondingly increased number of plural criteria to be judged are conceivable. Dependent on whether a respective criterion is met by the actual transaction information, different payment modes can be selected. Although in FIG. 3 each criterion is mapped to a different payment mode, it is conceivable that more than one criterion is mapped to one payment mode. For example, four criteria could be mapped to only two or three payment modes.

Also, the communication network used is not limited to a GSM network, a UMTS (Universal Mobile Telecommunications Standard) network or any other communication network is also applicable for the purpose of the present invention.

Accordingly, as has been described herein above, the present invention proposes a payment method for paying by a mobile terminal 1 through a communication network 3, 4, 5,6, the method comprising the steps of: providing S2 information on a transaction effected with a third party 2 using the mobile terminal 1, judging S4, S6, whether said information fulfills a predetermined criterion of a plurality of predetermined criteria, and selecting S5, S7, S8, dependent on the result of said judging step, a corresponding one out of a plurality of payment modes 8, 9, 10; Mode 1, Mode 2, Mode 3 for said transaction.

Although the present invention has been described herein above with reference to its preferred embodiments, it should be understood that numerous modifications might be made thereto without departing from the spirit and scope of the invention. It is intended that all such modifications fall within the scope of the appended claims.

1. A payment method for paying by a mobile terminal through a communication network the method comprising the steps of:
providing information on a transaction effected with a third party (2) using the mobile terminal,
judging whether said information fulfills a predetermined criterion of a plurality of predetermined criteria, and
selecting dependent on the result of said judging step, a corresponding one out of a plurality of payment modes for said transaction.

2. A method according to claim 1, wherein said information on said transaction is cost information representing the costs accrued for said transaction.

3. A method according to claim 1 or 2, wherein said information on said transaction is indicative of a type of transaction.

4. A method according to claim 1, wherein according to the selected payment mode, said information on said transaction is transferred to a corresponding destination.

5. A method according to claim 4, wherein if said selected payment mode is selected for transactions involving payments that are less than a specific amount, the payment amount is added to a communication network operators bill for a user of the mobile terminal, and the information on said transaction is transferred to a billing server.

6. A method according to claim 4, wherein for a specific selected payment mode, said information on said transaction is accumulated for plural individual transactions before being transferred to said corresponding destination.

7. A method according to claim 4, wherein if said selected payment mode is selected for transactions involving payments that are equal or more than a first specific amount the said transaction is individually transferred to said corresponding destination.

8. A method according to claim 4, wherein for a specific selected payment mode, said information on said transaction is individually transferred to said corresponding destination.

9. A method according to claim 1, wherein said predetermined criterion is user specific, and said method further comprises a step of providing information about said predetermined criterion for a user.

10. A method according to claim 1, wherein the transaction comprises the steps of choosing, by the mobile terminal, a vending machine, disclosing, by the vending machine, a telephone number which a customer, by means of the mobile terminal, may dial for buying a good/service offered by said vending machine, and dialing said disclosed telephone number.

11. A network element adapted to carry out the method as defined in claim 1.

12. A method according to claim 1, wherein the transaction comprises further the steps of, as a result of the information transferred to a corresponding destination, a destination network element requests validity from a certificate agency server.

13. A method according to claim 1, wherein the transaction comprises further the steps of, as a result of the information transferred to a corresponding destination, a destination network element sends a validity request from a certificate agency server that is in connection to a corresponding network element via a network connection.

14. A method according to claim 1, wherein the transaction comprises further the steps of, as a result of the information transferred to a corresponding destination a control block of the corresponding destination makes the payment transaction and returns a receipt.

15. A method according to claim 12 or 13, wherein the a transaction comprises further the steps of, as a result of the information transferred to a corresponding destination a control block of the corresponding destination makes the payment transaction and prior to the payment the user's signature is validated.

16. A method according to claims 12 to 14, wherein the transaction comprises further the steps of, after the payment transaction, a certificate validation or server returns a protection key of a digital product.

17. A method according to claims 12 to 14, wherein the transaction comprises further the steps of, after the payment transaction, a certificate validation and receipt of payment is given without a protection key of a digital product, and the protection key is requested from a product provider's vending machine.

18. A method according to claim 17, wherein the transaction comprises further the steps of, after the protection key is requested from the product provider's vending machines, it is returned to mobile terminal.

19. A method according to claim 1, wherein the transaction concerns a digital product comprising one of text, image, video and audio.

20. A method according to claim 1, wherein a receipt given as a result of made payment is stored in a payment server.

21. A method according to claim 1, wherein a receipt given as a result of made payment is stored in the mobile terminal.

22. A payment system which comprises:
a communication network,
wireless terminals available to communicate with the communication network, selling entities,
said communication network including identification information associated with service information of said wireless terminals, said service information describing a payment service identifier,
one of said wireless terminals buying in communication with the selling entities something to be paid,
wherein buying information from said one wireless terminal is transferred to the wireless network which selects a payment server depending on said service information of the one wireless terminal,
wherein payment is transferred with information of the buyer to the payment server having an external register including buyer information, the payment server charging the account of a user by his/her micropayment account.

23. A payment system as claimed in claim 22, wherein said service information includes an identifier of a bank.

24. A payment system as claimed in claim 22, wherein said service information includes a network address (IP address) of a payment server saved on a register of registered terminals.

25. A payment system as claimed in claim 22, wherein a the network address of the payment server is copied to other relevant registers of the network.

26. A payment system as claimed in claim 22, wherein there are one or more payment servers connected to the communication network.

27. A payment system as claimed in claim 22, wherein one payment server is a global server which has information to connect a wireless terminal user with his/her banking service provider and wherein said global server has means for linking an identifier of the user with the payment service identifier.

28. A payment system as claimed in claim 22, wherein a banking service provider has its own server for enabling the micropayment services to users separate from a bank account, and wherein transaction information is transferred and handled in the banking server.

29. A payment system as claimed in claim 22, wherein in said payment server the information of the buyer includes a mobile terminal identifier, service information and PKI information and micropayment account information.

30. A payment system as claimed in claim 22, wherein said service information includes information of a service provider in which the buyer has a bank account.

31. A payment system as claimed in claim 22, wherein said server includes information of parameters describing limits of usage of the account, charging practice, and bonus practice.

32. A payment system as claimed in claim 22, wherein the charging includes direct debiting, debiting based on the acceptance of the buyer, and debiting based on the predescribed message.

33. A payment system as claimed in claim 22, wherein the transaction information includes two parts from which one is a connection based charge and the other is a product payment relating charge.

34. A payment system as claimed in claim 22, wherein one of the selling entities is a vending machine.
